(19) United States
(12) Patent Application Publication
(10) Pub. No.: US 2005/0169237 A1
(43) Pub. Date: Aug. 4, 2005

(54) Method for the transmission of information via ip networks

(75) Inventors: Ramin Mirbaha, Dachau (DE); Vahid Mirbaha, Eching (DE)

Correspondence Address: BURNS DOANE SWECKER & MATHIS L L P, POST OFFICE BOX 1404, ALEXANDRIA, VA, 22313-1404, US

(73) Assignee: FG MICROTEK GMBH, MUNCHEN (DE)

(21) Appl. No.: 10/510,161

(22) PCT Filed: Mar. 27, 2003
(86) PCT No.: PCT/EP03/03203

(30) Foreign Application Priority Data
Apr. 5, 2002 (DE) 102 15 151.2

(51) Int. Cl. H04L 12/28; H04L 12/56

(52) U.S. Cl. 370/351; 370/401

(57) ABSTRACT

From an abstract perspective, the invention relates to 2 components. One component is arranged on a mobile terminal, information corresponding to the GPRS standard being embedded in IP packets in order to be transmitted to the second inventive component via an IP tunnel. The second component represents an IP serving GPRS support node (IP-SGSN) in the IP network, which receives the packets from the tunnel and unpacks the packets so as to subsequently send them on to another GSN, for example. The additional GSN is responsible for other mobile terminals or makes it possible to establish a connection to the internet (GGSN). The second component consequently has the form of a conventional SGSN towards the outside for additional GSN while being considered as the end of a tunnel in the direction of the mobile terminal.

The invention relates to a method for the transmission of information via IP networks. In particular it relates to a method for the transmission of information by means of mobile terminals, such as mobile phones or PDAs, which are equipped, among other things, with access to conventional radio networks such as GSM or UMTS. If these devices are to work in a pure IP-based network such as UMTS or wireless LAN, it is expedient to utilize existing standards, on the one hand to achieve a simple bridge to existing technologies and on the other hand to make them easy to use.

GPRS for GSM and UMTS enable a packet-oriented network on the basis of UMTS and GSM on the last mile. The advantages of so-called packet-oriented domains are their compatibility with one another and with the internet. Thus there are a range of applications that have been specifically developed for IP-based networks. It is evident from this that GPRS will be a very important component of new UMTS networks. Owing to the limitations of UMTS in very highly frequented areas such as those found in the environment of a company or a university for example, UMTS will not be capable of meeting all needs. It will thus be virtually impossible for a provider to handle all tasks with an UMTS-GSM network. Wireless LAN (IEEE802.11(x), ETSI Hiperlan), for example, will be adopted in such areas in order to take the load off the UMTS infrastructure. It is important in such a mixed architecture that communication is possible between the different domains.

The object of the invention is to provide a method and a device that enable interoperability, irrespective of the type of network the mobile user is in.

This object is achieved by the inventions in accordance with the features of the independent claims. Advantageous further developments of the inventions are set out in the subclaims.

From an abstract perspective, the invention comprises two components. One component is arranged on the mobile terminal, with information conforming to the GPRS standard being embedded in IP packets in order to be transmitted to the second inventive component via an IP tunnel. Said second component is an IP serving GPRS support node (IP-SGSN) in the IP network, which receives the packets from the tunnel and unpacks them so as to subsequently send them on to another GSN, for example, which GSN is in turn responsible for other mobile terminals or enables a connection to the internet (GGSN). The second component consequently has the form of a conventional SGSN toward the outside for additional GSNs, while being considered as the end of a tunnel in the direction of the mobile terminal. When information is tunneled, packets of a different protocol are packaged in an IP packet so that a complete packet, in this case a GPRS packet, is found in the data part of the IP packet.

In detail it relates to a method for the transmission of information by means of GPRS in an IP network, in particular a wireless LAN and/or a Hiperlan network, having a preferably mobile terminal which is connected to the IP network so that IP packets can be exchanged. A further component of the invention is an IP serving GPRS support node in the IP network, wherein, during initialization of the connection between the terminal and the IP serving GPRS support node, a tunnel which tunnels GPRS information is established on the basis of IP packets. In the text below the information is transmitted through the tunnel. The IP serving GPRS support node is connected via an IP network to further serving GPRS support nodes, gateway GPRS support nodes, as well as other GPRS service nodes (e.g. for SMS), wherein, depending on the direction of communication, the IP SGSN unpacks and/or repacks the information in order to send the information to the further GPRS service nodes, or packs the information in order to send it through the tunnel to the terminal.

Owing to the special nature of this method, it is necessary to install additional software on conventional mobile terminals which transparently handles the packing and unpacking of information for the user. Said software is moreover designed in such a way that it tries to find an IP SGSN as soon as it is able to establish contact to an IP network. This software is designed in such a way that tunneled GPRS information can be packed and unpacked.

During initialization of the connection it is checked whether the mobile terminal is permitted access to a GPRS network, with known security checks based on the GPRS mode being performed. This authentication is likewise effected through transmission of tunneled information. A corresponding module, as described further below, is part of the software. It is however also conceivable for the software to interface with the existing authentication procedures on the mobile terminal so that no separate module is required.

To establish a connection, a broadcast message is preferably transmitted to seek an IP serving GPRS support node in the IP network through which a tunnel is established.

In a preferred embodiment, it is furthermore possible for an HLR service to be present which permits authorization and/or locating of the terminal both on the basis of the IP address of the terminal and on other typical GPRS information (which is present on the mobile terminal, e.g. in the form of a subscriber identity module (SIM)). Such an HLR service has the task of determining and storing where a mobile terminal is located and to whom it is allocated, or what telephone number it is assigned. By means of the HLR service the network provider additionally assigns user-specific and/or device-specific rights which, owing to the special nature of this method, can also be used in non-GSM/UMTS networks.

For mobile networks in particular the way in which a handover is effected between the base stations is important. Such a handover takes place whenever the mobile terminal moves out of the receiving range of one base station into the receiving range of another base station. In the preferred embodiment, a handover can be performed both on the IP level and on the GPRS level. The form of the handover depends on the network in which the terminal is located, or rather between which network types the handover is taking place. If the mobile terminal is to remain, for example, in the range of a wireless network, then the handover is preferably performed on the basis of IP. If, on the other hand, a change of domains is to occur, then the handover can be performed on the basis of GPRS. As a special feature, this application utilizes a mechanism that predicts the future trend of the connection quality of the different network types. By virtue of this prediction, the handover from one network type to another is optimized in terms of time.

In the case of mobile and wireless communications, it is advantageous if the information is encrypted. In the preferred embodiment, IPSec is used on the IP level. It is however also conceivable to use other encryption methods. A plurality of methods can also be used in parallel.

As already mentioned above, in addition to the method a device is also a component of the invention; said device is arranged in the IP network and functions there as an IP SGSN. This is a device for providing GPRS services in an IP network, having means that enable a known functionality of a serving GPRS support node in a GPRS and/or UMTS network. By virtue of this complete compatibility with known SGSNs and GGSNs (gateway GSNs), communication with existing networks is accomplished without any great technical outlay. The special nature of the device lies however in the fact that communication with the preferably mobile terminals is performed on the basis of an IP tunnel, with GPRS packets being transmitted through the IP tunnel.

As already described above, the IP SGSN can be used in any IP-based network. It is designed in such a way that it can establish connections to SGSNs, GGSNs, HLRs, CGFs in the UMTS/GSM home network. From the point of view of an UMTS network, therefore, it is a normal “3G” SGSN, as specified in the 3GPP documentation.

In conjunction with the modified HLR service, the IP SGSN can route different services to different servers. (E.g. internet and e-mail to “local” proxy and mail servers, or other GPRS services to GGSNs of the UMTS/GSM provider).

The specific HLR and CGF are not essential components for “GPRS via an IP-based network”. Rather they enable further functionalities that network providers would like to offer their customers.

The modified HLR functions like a known transparent HLR in the IP-based network. It has a list of all holders that enable roaming. In this case the HLRs are ones from UMTS/GSM providers who have concluded roaming agreements with each other. Thus the IP SGSN interrogates the modified HLR instead of another one. The modified HLR decides whether the packet is to be sent from the IP SGSN to an HLR, and if yes, to which one. The provider can likewise manage his own subscriber list in the modified HLR. Moreover, the provider can manage a list in this HLR in which the offered services available to the user are stored.

The modified CGF likewise functions transparently like a known CGF, but in the IP-based network. This makes it possible to collect information that enables the costs or charges to be calculated for the user. Instead of establishing a connection to a conventional CFG, the IP SGSN establishes a connection to the modified CGF. The CGF modified in this way can forward the information to the provider or make its own calculations.

In a preferred embodiment, the device has means which provide a gateway functionality, in particular the routing of information into other networks. In this case it is an IP-GGSN. Equivalent systems are known from the other networks.

As already mentioned above, the device can likewise assume the functionality of an HLR. In this case it should be mentioned in particular that means are present which enable the mapping of an IP address in an HLR. Moreover, both means for enabling a handover on the different protocol layers and protocols, and means for enabling encryption are present.

Further components of the device are means which can receive broadcast messages of a terminal in order to establish a GPRS tunnel connection thereby. After such a packet has been received, a reply is sent to the mobile terminal, from which the mobile terminal can tell that an IP SGSN is present in the network.

Another component of the invention is a terminal which is capable of communicating with the IP SGSN through a tunnel connection. Conventional terminals such as PDAs or mobile phones do not however have such functionality. Rather it requires modification of the software and possibly the hardware to make such communication possible. In essence, said modified terminals have means which enable information to be exchanged via GPRS through an IP tunnel. The prerequisite is of course that a corresponding IP SGSN is available for communication.

A preferred embodiment is a device that supports multiple radio standards. The device can thus preferably support both wireless LAN as well as UMTS or GSM/GPRS.

Owing to its use in IP networks, known methods of address conversion should be implemented. This allows greater flexibility when used in networks that support, for example, different IP versions. Thus address conversion should be permitted, in particular from IPv4 to IPv6 and vice versa, as well as NAT or address masquerading.

In addition, means are present in the preferred embodiment that enable encryption of the information. Options for encryption have already been discussed above. During initialization in particular it is important for means that enable authentication in the GPRS network to be present. The HLR is preferably accessed in this case. This approach enables the clear allocation of costs.

A software layer that enables the functionality described is present in the preferred embodiment, said layer preferably having access to an IP stack. Simple implementation is possible by virtue of the picking up or rerouting of the information in the IP stack, which is present for GPRS and UMTS terminals.

A further component of the invention is software that implements the described functionality on a conventional terminal. Note that the protection is likewise to be extended to a data carrier with such software.

As a result of this approach, new network types are readily integrated in existing networks. The functionality of the known networks can continue to be utilized, with it being possible to make use of the new technologies being provided by the new networks.

The invention is explained in greater detail below with reference to exemplary embodiments schematically illustrated in the figures. The same reference numerals denote the same elements in the individual figures. In detail:

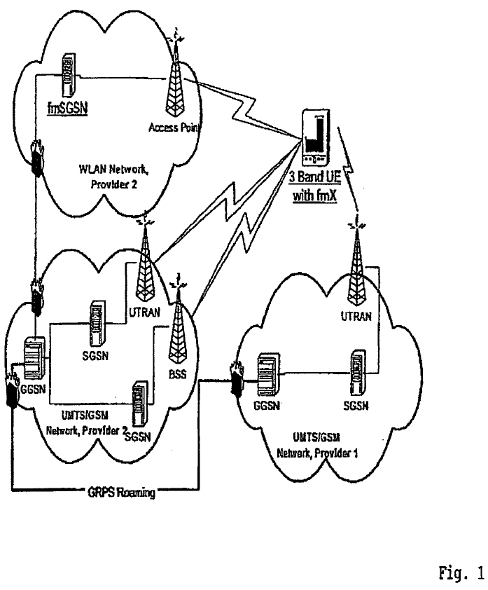

FIG. 1 shows a mobile terminal that supports 3 bands, namely UMTS, GSM and WLAN, which are used in different domains in each case, with the mobile terminal being connected via base stations to SGSN, which in turn establish the connection to different domains via GGSNs;

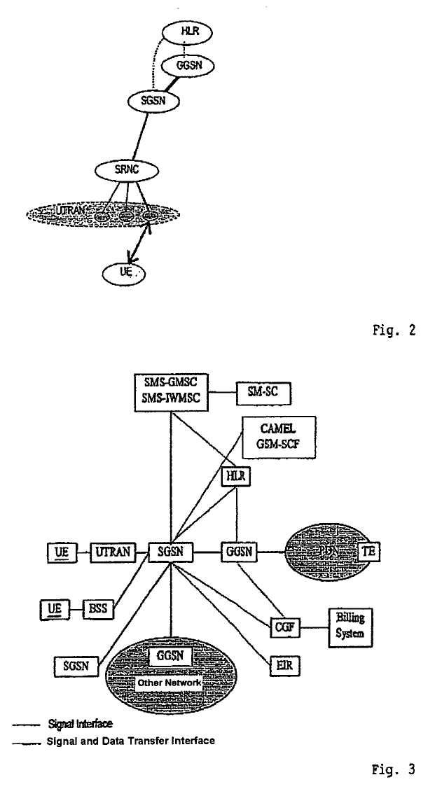

FIG. 2 shows a hierarchy beginning with terminals (UE) via base stations (UTRAN), (serving) radio network controller, SGSN, GGSN, as well as HLR;

FIG. 3 shows a logical architecture of a (UMTS) GPRS network;

FIG. 4 shows user layers for GPRS via GSM;

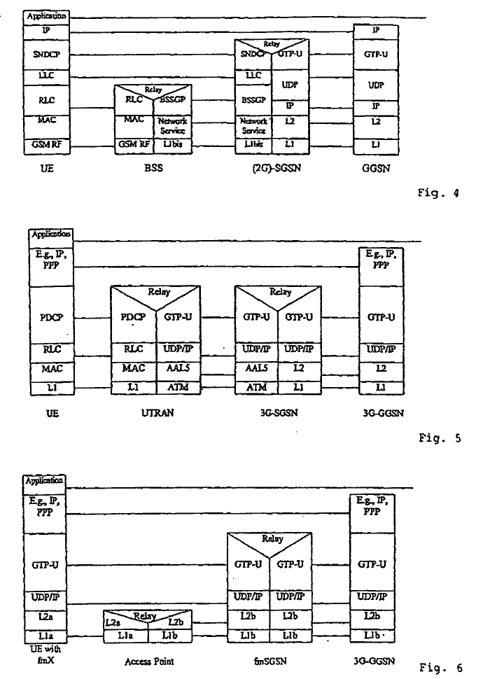

FIG. 5 shows user layers for GPRS via UMTS;

FIG. 6 shows user layers for GPRS via IP;

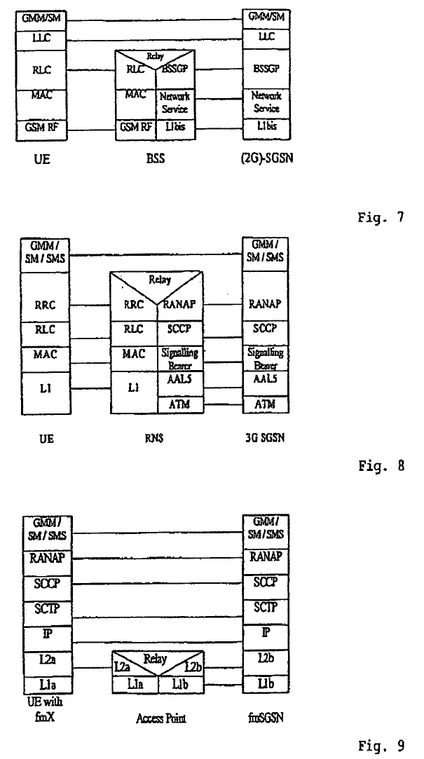

FIG. 7 shows control layers for GPRS via GSM;

FIG. 8 shows control layers for GPRS via UMTS;

FIG. 9 shows control layers for GPRS via IP;

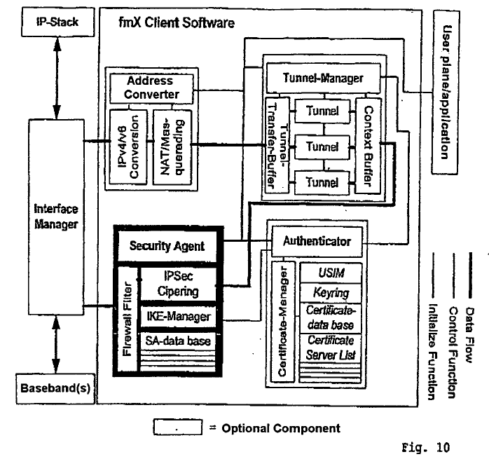

FIG. 10 shows the structure of the software module arranged on a mobile terminal.

FIG. 1 shows a mobile terminal that supports 3 bands, namely UMTS, GSM and WLAN, which are used in different domains in each case. The mobile terminal moves through the networks, with roaming taking place via GPRS. To effect this, appropriate gateways (GGSNs) must be used to establish the connection between the networks. In the network in which the WLAN is employed, the IP SGSN (fm SGSN) according to the invention which communicates via an IP tunnel with the terminal is used. For further communication, the information is transported via the SGSNs and GGSNs.

FIG. 2 shows a hierarchy as found in known (UMTS) networks. Details of this may be found in the literature [13]. The hierarchy begins with a terminal (UE) which is connected by means of radio via base stations (UTRAN), via a (serving) radio network controller (SRNC), to SGSN, GGSN. The SGSN and GGSN have access to the HLR. The radio network controller has the job of allocating the bandwidth and frequencies or time slots.

FIG. 3 shows a logical architecture of a GPRS network as is known from [13]. It can be seen from this figure that the network is essentially constructed of the SGSNs and the GGSNs, which on the one hand control the connection of the mobile terminals in the domains, and on the other hand enable the connection to other networks. A plurality of GGSNs connected to one another may be present in a network. The SMS-GMSC and SMS-IWMSC are units employed for SMS exchange. Further details may be found in [13].

FIGS. 4, 5 and 6 show the user layers of the known GPRS via GSM/UMTS protocol and of the GPRS protocol tunneled via IP. Reference is made to the literature [13] here. It is clear that the tunneled protocol GTP-U in FIG. 6 is used both between the GGSN and between the terminal. This serves to transport the IP packets. Only the GTP-U protocol on a UDP/IP layer is used. In contrast to UMTS, it does not require a base station that additionally communicates with the terminal via the packet data convergence protocol. A direct tunnel to the terminal is therefore provided. See the literature [20] for further details.

FIGS. 7, 8 and 9 show the differences on the control layer.

As a further layer, the Radio Access Network Application Protocol (RANAP) is used, as described in [20]. This protocol encapsulates and transports information and signals on higher layers. The layers below RANAP are described in [14]. SCCP should be used for transporting RANAP information. This should conform to the ITU-T white book.

The present invention is essentially based on a server and a client. Both the client and the server must support GPRS via IP.

The modules of the client support a range of new standards such as (3GPP specs, IETF RFCs) or drafts that are not part of the IP stack, but rather are based on it. The modular design has the advantage that modification is simple.

The structure of the client can be seen from FIG. 10.

The authenticator is responsible for the management of various information such as passwords, public and private keys, certificates and USIM. It likewise includes methods for authentication. Authentication according to the GSM and UMTS standards, as set out in [10] and [25], is necessary for GPRS via IP-based networks.

The security agent is responsible for the security and integrity of the connection. It uses encryption methods and packet-based filters and firewall mechanisms. For GPRS via IP-based networks, IPSec with IKE (Internet Key Exchange, [28]) should be supported.

There are other modules besides the two modules, namely the tunnel manager and the address converter.

The tunnel manager is responsible for the tunnel management and the handover of tunnel endpoints. For GPRS via IP-based networks, GTP ([22]) should be supported.

The address converter has the job of address conversion, usually from IPv4 to IPv6 ([30]) and vice versa. This is necessary because the stacks of the terminals only support Version 4. Older networks are likewise oriented to the older versions. In contrast, newer networks, such as UMTS, are based on the newer versions. Conversion is necessary in particular when a handover takes place between the different networks. Support for masquerading or address translation is likewise of interest ([29]).

### REFERENCES

[1] GSM 01.61, General Packet Radio Service (GPRS); GPRS ciphering algorithm requirements
[2] GSM 03.40, Technical Realization of the Short Message Service (SMS) Point-to-point (PP)
[3] GSM 04.08, Mobile radio interface layer 3 specification
[4] GSM 04.60, General Packet Radio Service (GPRS); Mobile Station (MS)—Base Station System (BSS) interface; Radio Link Control/Medium Access Control (RLC/MAC) protocol
[5] GSM 04.64, General Packet Radio Service (GPRS); Mobile Station—Serving GPRS Support Node (MS-SGSN) Logical Link Control (LLC) layer specification
[6] GSM 04.65, General Packet Radio Service (GPRS); Mobile Station (MS)—Serving GPRS Support Node (SGSN); Subnetwork Dependent Convergence Protocol (SNDCP)
[7] GSM 08.16, General Packet Radio Service (GPRS); Base Station System (BSS)—Serving GPRS Support Node (SGSN) Interface; Network Service
[8] GSM 08.18, General Packet Radio Service (GPRS); Base Station System (BSS)—Serving GPRS Support Node (SGSN); BSS GPRS Protocol
[9] GSM 09.02, Mobile Application Part (MAP) Specification
[10] 3GPP TS 23.003 v5.1.0, Numbering, Addressing and Identification
[11] 3GPP TS 23.015 v4.0.0, Technical realization of Operator Determined Barring (ODB)
[12] 3GPP TS 23.040 v5.1.0, Technical realization of Short Message Service (SMS)
[13] 3GPP TS 23.060 v4.2.0, General Packet Radio Service (GPRS) Service description; Stage 2
[14] 3GPP TS 23.121 v3.5.1, Architecture Requirements for release 99
[15] 3GPP TS 24.008 v5.1.0, Mobile Radio Interface Layer 3 specification; Core network protocols; Stage 3
[16] 3GPP TS 25.301 v4.1.0, Radio Interface Protocol Architecture
[17] 3GPP TS 25.321 v4.2.0, Medium Access Control (MAC) protocol specification
[18] 3GPP TS 25.322 v4.2.0, Radio Link Control (RLC) protocol specification
[19] 3GPP TS 25.323 v4.2.0, Packet Data Convergence Protocol (PDCP) specification
[20] 3GPP TS 25.413 v4.2.0, UTRAN Iu interface RANAP signalling
[21] 3GPP TS 29.002 v4.5.0, Mobile Application Part (MAP) specification
[22] 3GPP TS 29.060 v4.2.0, General Packet Radio Service (GPRS); GPRS Tunnelling Protocol (GTP) across the Gn and Gp interface
[23] 3GPP TS 29.061 v4.2.0, Interworking between the Public Land Mobile Network (PLMN) supporting packet-based services and Packet Data Networks (PDN)
[24] 3GPP TS 32.215 v4.0.0, Telecom Management; Charging management; Charging data description for the Packet Switched (PS) domain
[25] 3GPP TS 33.102 v4.2.0, 3G security; Security architecture
[26] RFC 2002, IP Mobility Support
[27] RFC 2284, PPP Extensible Authentication Protocol (EAP)
[28] RFC 2409, The Internet Key Exchange (IKE)
[29] RFC 3022, Traditional IP Network Address Translator
[30] RFC 3089, A SOCKS-based IPv6/IPv4 Gateway Mechanism

1. A method for the transmission of information by means of GPRS in an IP network, in particular a wireless LAN and/or a Hiperlan network, having a preferably mobile terminal which is connected to the IP network so that IP packets can be exchanged, with an IP serving GPRS support node in the IP network,
wherein, during initialization of the connection between the terminal and the IP serving GPRS support node, a tunnel which tunnels GPRS information is established on the basis of IP packets,
wherein the information is transmitted through the tunnel,
wherein the IP serving GPRS support node is connected via a network to further serving GPRS support nodes and, depending on the direction of communication, unpacks and/or repacks the information in order to send the information to the further serving GPRS support nodes, or packs the information in order to send it through the tunnel to the terminal.

2. The method as claimed in claim 1, wherein software which unpacks the tunneled GPRS information is installed on the mobile terminal.

3. The method as claimed in claim 1, wherein during initialization of the connection a check is made whether the mobile terminal is permitted access to a GPRS network, with known security checks based on the GPRS mode being performed.

4. The method as claimed in claim 1, wherein broadcast messages are used to seek an IP serving GPRS support node in the IP network in order to establish a tunnel.

5. The method as claimed in claim 1, wherein an HLR service is present which permits the terminal to be determined and/or located both on the basis of the IP address of the terminal and on the address information of GPRS.

6. The method as claimed in claim 1, wherein a handover may be performed both on the IP level and on the GPRS level, depending on the network in which the terminal is located.

7. The method as claimed in claim 1, wherein encryption is performed on the GPRS and/or IP level, preferably by means of IPSec.

8. A device for providing GPRS services in an IP network, having means that enable a functionality of a serving GPRS support node in a GPRS and/or UMTS, and further including means which enable communication with a terminal via GPRS through an IP tunnel.

9. The device as claimed in claim 8, further including means which enable a gateway functionality, in particular the routing of information into other networks.

10. The device as claimed in claim 8, further including means which enable the mapping of an IP address in an HLR.

11. The device as claimed in claim 8, further including means with which a handover may be performed both on the IP level and on the GPRS level, depending on the network in which the terminal is located.

12. The device as claimed in claim 8, further including means which enable encryption on the GPRS and/or IP level, preferably by means of IPSec.

13. The device as claimed in claim 8, further including means which can receive broadcast messages of a terminal in order to establish a GPRS tunnel connection thereby.

14. A terminal having means for communication in an IP network, in particular a mobile terminal, and means that enable information to be exchanged via GPRS through an IP tunnel.

15. The terminal as claimed in claim 14, wherein the terminal supports both wireless LAN and UMTS and/or GSM.

16. The terminal as claimed in claim 14, further including means which enable address conversion, in particular from IPv4 to IPv6 and vice versa, as well as NAT and/or masquerading.

17. The terminal as claimed in claim 14, further including means which enable encryption of the tunneled information, or encrypt the tunnel packets themselves, with IPSec preferably being used.

18. The terminal as claimed in claim 14, further including means which enable authentication in the GPRS network.

19. The terminal as claimed in claim 14, further including a software layer that enables the functionality described, said layer preferably having access to an IP stack.

20. Software for a terminal in an IP network, in particular a mobile terminal such as a PDA or a mobile phone, that implements a process which enables information to be exchanged via GPRS through an IP tunnel.

21. A data carrier having a data structure that can be loaded into a terminal, wherein the data structure includes the software according to claim 20.
